(19) United States
(12) Patent Application Publication
(10) Pub. No.: US 2005/0176424 A1
(43) Pub. Date: Aug. 11, 2005

(54) Method and system for accessing wireless networks

(76) Inventors: G. V. Kumar, Banjara Hills (IN); S. Mohan Kumar, Banjara Hills (IN)

Correspondence Address: ARENT FOX PLLC, 1050 CONNECTICUT AVENUE, N.W., SUITE 400, WASHINGTON, DC, 20036, US

(21) Appl. No.: 10/996,072

(22) Filed: Nov. 24, 2004

Related U.S. Application Data
(60) Provisional application No. 60/524,718, filed on Nov. 25, 2003.

(51) Int. Cl. H04Q 7/20

(52) U.S. Cl. 455/432.1; 455/433

(57) ABSTRACT

A network-based system and method that provides control of routing of communication signals from wireless communication devices of roaming subscribers of mobile communication service provider via an automated and intelligent network/system. The system provides real-time routing to preferred mobile communication service provider, which are affiliated with the home mobile communication service provider. The system improves the quality of service delivered to the roaming subscriber and increases potential revenues to the home mobile communication service provider by providing control over the roaming subscriber and preference use of the preferred mobile communication service provider.

This application is related to applicant's copending U.S. Nonprovisional patent application Ser. No. 10/850,561 of G. V. Kumar and G. V. R. Nagaraju, titled “System for A Wireless Intelligent Services Engine” filed May 21, 2004 and U.S. Provisional Patent Application Ser. No. 60/524,718 of G. V. Kumar and S. Mohan Kumar titled “Xius Power Roam” filed Nov. 25, 2003. The entirety of these patent applications is incorporated herein by reference.

### BACKGROUND OF THE INVENTION

Field of the Invention

The present invention relates to a network-based system and method that provides control of routing of communication signals from wireless communication devices of roaming subscribers of mobile communication service provider via an automated and intelligent network/system.

### BACKGROUND OF THE TECHNOLOGY

A Mobile Carrier Network (interchangeably referred to herein as a “MCN” or “Network”), such as, for example, a wireless mobile phone network, typically serves numerous subscribers. Subscribers are provided access to the MCN using mobile communication devices (interchangeably referred to herein as “mobile devices”), such as telephones, to exchange or communicate information. The MCN to which the subscriber has a subscription or contractual obligation is known generally as a “home MCN” (interchangeably referred to herein as “home network” and/or the “home MCN provider”).

When the subscriber operates the mobile device (e.g., by turning it “on” or by dialing a telephone number on a telephone), the subscriber instructs the mobile communication device to transmit signals to a second mobile device, also known as an “end user,” or to one or more MCN control centers.

Each MCN has a specified geographic area of operation, generally known as “range” or “home area.” When the subscriber operates the mobile device within the range of the home MCN (e.g., the subscriber is located the home area), the subscriber's signals are carried or transmitted to the end user or a signal receiver of the home MCN via the home MCN.

It is possible, however, that the subscriber cannot access the home MCN, for example, in the following circumstances: when the subscriber operates the mobile device outside the home MCN area, the home MCN is out of service, the home MCN communication signal strength is less than that of other MCNs, or the home MCN is otherwise unavailable.

Fortunately, in such circumstances, subscribers may be able to access another interconnected, technologically compatible, and available MCN. The use of the interconnected MCN (i.e., non-home MCN) by the subscriber is generally known in the art as “roaming.” Accordingly, the interconnected MCN is generally known as a “roaming MCN or a “roaming Network.” A roaming subscriber generally refers to a subscriber who cannot access the home MCN for whatever reason.

When powered “on” or otherwise instructed or programmed, conventional technology dictates that the mobile device detects the signal strengths coming from the available roaming MCNs. Conventional systems are generally limited to selection of MCNs based only on the strength of compatible signals. Accordingly, neither the subscriber nor the home MCN can choose whether a specific roaming MCN is selected and which roaming MCN is to be used in the event multiple MCNs are available.

A roaming subscriber is a source of revenue for the home MCN provider. In particular, home MCN providers (e.g., mobile phone providers) could generate increased revenue by facilitating roaming use (i.e., transmission of communication signals) on proprietary or designated MCNs, or MCNs generally affiliated with the home MCN. These affiliated MCNs are referred to interchangeably as “preferred MCNs” or “preferred networks.”

The term “preferred MCNs” or “affiliated MCNs” defines the relationship between the home MCN and the roaming MCN. The relationship is typically characterized by an agreed-upon arrangement between the home MCN and the roaming MCN, wherein use of the preferred MCN typically results in at least one benefit for the home MCN or for the home MCN subscribers. The benefits to the MCN may include increased revenue and other financial advantages as well as increased subscriber happiness and loyalty (e.g., by providing high quality roaming service).

Typically “preferred” status is conferred by contractual obligation. By controlling the selection of the roaming MCN, the home MCN generally increases revenues and can ensure the quality of service, which is generally higher on preferred MCNs as compared to unaffiliated, third-party MCNs (herein referred to as “unaffiliated MCNs”). Preferred status can also be conferred through one or more of the following (collectively referred to as “business practices”): subscriber service offering requirements, network capacity, and arbitrary preferences of the home MCN, such as operator-specific requirements, subscriber-specific requirements, network-specific requirements, and business requirements.

For the foregoing reasons, it is highly beneficial for the home MCN provider to be able to direct the traffic of signals of the roaming subscribers to selected MCNs, and more specifically, for the home MCN to direct the subscribers to preferred MCNs when the subscriber cannot access the home MCN.

The technology is, however, presently unavailable in the conventional art without performing hardware modifications to each subscriber's mobile device. Presently, the home MCN provider can only control the roaming MCN by modifying the logic of a Subscriber Identification Module (“SIM”), which is found at the individual mobile device level. For example, each mobile telephone containing a SIM device must be modified directly to allow home MCNs to control the selection of the roaming MCN. Modification of the SIM typically requires increased cost, in part from servicing, modification, reconfiguration or replacement of the SIM, and an inherent reliance on SIM vendors by the home MCN. Consequently, the home MCN cannot currently control and/or ensure the use of a designated roaming MCN, like a preferred MCN without investing substantial resources to upgrade each mobile device.

It should also be noted that the subscriber typically has a vested interest in ensuring the use of preferred MCNs when the subscriber is not able to access the home MCN. Generally, subscribers pay a differential premium (e.g., cost) to use unaffiliated MCNs. Typically, the use of preferred MCNs, would reduce subscriber costs and/or provide improved or assured quality of service. Accordingly, it is beneficial to the subscriber to use the preferred MCNs to reduce premiums and/or to avoid differential premiums.

Additionally, subscribers selecting the home MCN typically select the home MCN based on overall service, including the quality of service and the price. If it were feasible, this selection process based on quality would likely extend to the selection of roaming MCNs. However, without control of the roaming MCN by the home MCN, the subscriber is subject to the roaming MCN having the strongest signal, for example, and not necessarily the roaming MCN providing the highest quality. It is likely that the home MCN will attempt to maintain the quality service, which the subscriber has come to expect from the home MCN. Thus, by allowing the home MCN to select a preferred MCN for a roaming subscriber, the quality of service would be maintained. Accordingly, subscribers have a great interest in ensuring the use of a high quality roaming MCN.

There remains an unmet need for service providers to control and ensure the use of preferred MCNs, when subscribers are unable to use the home MCN and when multiple roaming MCNs are available to the subscriber. Furthermore, there is an unmet need for seamlessly and globally directing the communication signals from the subscribers' mobile devices to preferred MCNs using a network-based solution, rather than performing numerous individual hardware modifications/upgrades on each subscriber's mobile device. Moreover, there is an unmet need for subscribers of home MCNs to connect with roaming MCNs that have the reliability and the quality of the home MCN. Additionally, there remains an unmet need for a method for controlling the routing of signals to preferred MCNs for subscribers of home MCNs via an automated network for wireless communication devices.

### SUMMARY OF THE INVENTION

The present invention meets the unmet needs in the art by providing a network-based system for controlling the routing of communication signals for roaming subscribers of a home MCN. The present invention is fully scalable and customizable, is operable using industry standard applications, and is implemented at the network level.

One embodiment of the present invention analyzes a request for roaming service sent by one or more roaming MCNs and/or the subscriber. Using one or more data stores, processing systems, and/or a mobile switching center of the home MCN, the present invention processes the location of the subscriber, available MCNs, and preferences related to the list of available MCNs. The present invention allows the home MCN to choose the most preferred roaming MCN.

In accordance with another embodiment, the present invention ensures that a roaming mobile device uses a preferred MCN, if available, to send and receive communication signals. In one variation, the mobile device transmits a request to use a roaming network to one or more available roaming MCNs. The MCNs instantaneously relay the subscriber's location and a request to serve as the roaming MCN to the home MCN. The home MCN, in turn, analyzes the availability and preference information of each roaming MCN. The home MCN selects the preferred MCN, based on ranking criteria customizable by the home MCN, including contractual obligations between the home MCN and roaming MCNs. In another variation, if no preferred MCNs are available, the present invention selects an unaffiliated MCN.

In a further embodiment, the subscriber signals the home MCN to request a roaming provider from the home MCN. The home MCN selects one of the available MCNs on behalf of the subscriber. The present invention approves and selects the preferred roaming MCN to serve as the MCN for the roaming subscriber. If the preferred MCN is unavailable, the present invention selects an unaffiliated MCN.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 provides a representative flow diagram of the deployment and functioning of the present invention;

FIG. 2 provides a flow diagram of the system functionalities, in accordance with an embodiment of the present invention; and

FIG. 3 presents an exemplary system diagram of various hardware components and other features, for use in accordance with an embodiment of the present invention.

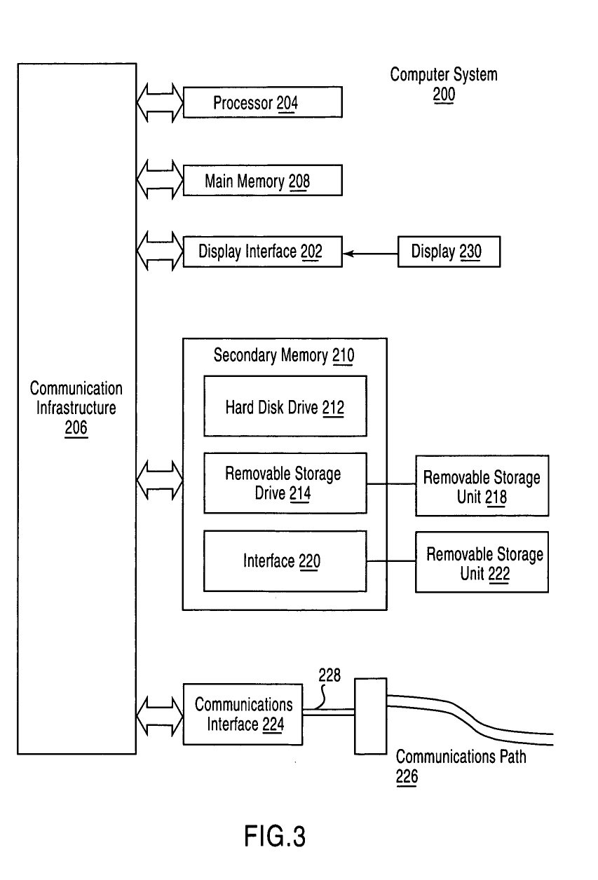

Other features of the present invention will become apparent from the following detailed description considered in connection with the accompanying drawings, which disclose multiple embodiments of the present invention. It should be understood, however, that the drawings are designed for the purpose of illustration only and not as a definition of the limits of the invention. Additional advantages and novel features of the invention will also become apparent to those skilled in the art upon examination of the following or upon learning by practice of the invention.

### DETAILED DESCRIPTION OF THE PRESENT INVENTION

The present invention relates to a network-based system for controlling the routing of communication signals originating from roaming subscribers of the home MCN to preferred MCNs. Generally, the present invention ensures that the subscriber of the home MCN operates the mobile device (e.g., sending and/or receiving communication signals on devices such as a telephone) primarily on the home MCN, and when roaming, primarily on a preferred MCN. The present invention is a preferred roaming control method and system and is fully scalable, fully customizable, and applicable with general industry standards, in accordance with one embodiment.

The present invention is a network-based solution to selecting and/or designating roaming MCNs. By “network-based,” it is meant that the present invention is implemented system-wide without hardware modifications on particular devices, such as telephones. Accordingly, as understood by one skilled in the art, the system implementation of the present invention is transparent to subscriber.

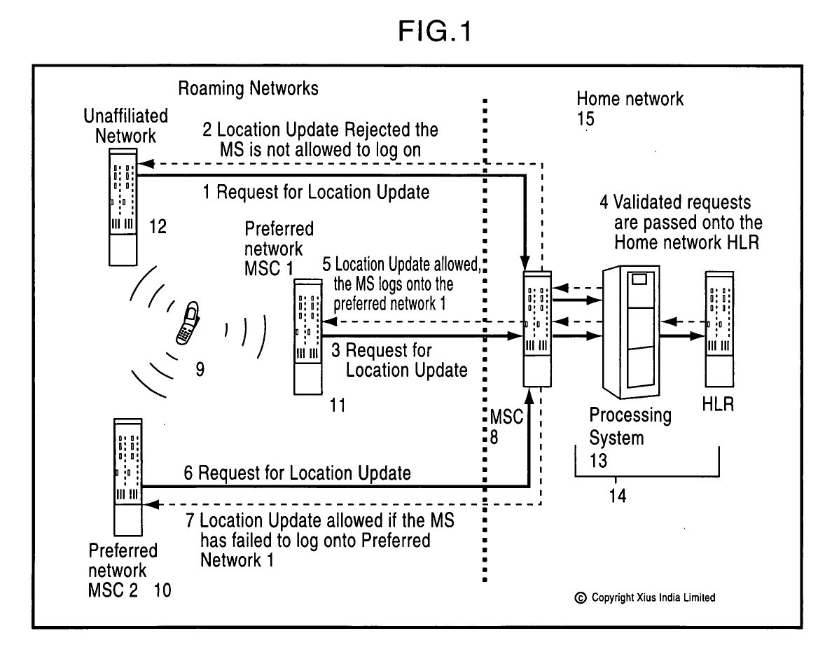

FIG. 1 illustrates one embodiment of the present invention. Signals originating from the mobile device 9 are received by the roaming MCNs 10, 11, 12, which optionally possess service authentication and certification functionality. The signals are then transmitted directly to the home MCN 15, and more specifically to a “mobile switching center (MSC) 8 of the home MCN 15. The MSC 8 functions as a receiving, processing, relaying, and terminating system between roaming MCNs 10, 11, 12 and the home MCN 15. Typically, when the mobile device 9 is roaming, the signals are indirectly transmitted to the MSC 8 of the home MCN 15 via roaming MCNs 10, 11, 12, each of which requests location information and authorization to carry the communication signals of the mobile device 9. The MSC 8 transmits a subsequent signal to a processing system 13 and a MCN data store 4, which contains information on subscribers (e.g., in a home location register (HLR)), signaling information (e.g., compatibility specifications) on the home MCN, available preferred MCNs, available unaffiliated MCNs, and the business practices of the home MCN 15. The processing system 13 and MCN data store 4 are collectively known as the “System” 14. The System 14 selects a “preferred” roaming MCN 10, 11 and provides the preferred roaming MCN 10, 11 with location information and authorization to carry the communication signals. If multiple preferred roaming MCN 10, 11 are available, the System 14 ranks the preferred roaming MCNs 10, 11 and selects the most preferred. If no preferred roaming MCN 10, 11 is available, the System 14 selects an unaffiliated roaming MCN 12.

The System 14 is typically implemented in conjunction with the home MCN 15 and/or the roaming MCNS 10, 11, 12 and/or any signaling transfer point (STP) and/or a signaling gateway. Communication is facilitated using any communication link, including industry standard protocols, such as the common channel signaling system no. 7 (“SS7”), common channel signaling system no. 8 (“SS8”), transmission control protocol (TCP)/internet protocol (IP), or other signaling protocols that are currently known or will be known in the art. In one embodiment, the present invention is integrated with or connected to the home MCN 15 hardware, software or any other processing device known in the art for receiving and/or processing of roaming signals, such as the MSC 8.

The deployment and integration of the System 14 may involve the following functions: controlling the use and access of roaming MCNs by mobile devices of the home MCN; checking the availability of roaming MCNs on which roaming mobile devices of the home MCN can operate; determining whether the communication signals of the roaming MCNs are compatible with the signals of the home MCN; initiating and terminating the registration and authentication process of available roaming MCNs; receiving signals from the MSC; determining the origin of the signals; authenticating the signals originating from mobile devices; analyzing signals; determining the availability of roaming MCNs; processing requests from roaming MCNs; communicating with one or more data stores (e.g., HLR); identifying the geographic location and range of available roaming MCNs; categorizing the available roaming MCNs based on preferred status as determined by the home MCN; ranking the available preferred and unaffiliated MCNs; selecting a preferred MCN; selecting an unaffiliated MCN when a preferred MCN is not available; providing authorization to carry roaming communication signals to the selected MCN; confirming and responding to requests from roaming MCNs and/or mobile devices; and providing log on and authentication information to selected roaming MCNs.

In one embodiment, the MSC 8 at the home MCN 15 is configured to route all or selected signals coming from the mobile device 9 of the subscriber, and/or communications from other MCNs 10,11, 12, to the System 14. In one variation, the signal from the mobile device 9 is received directly by the home MCN 15 MSC 8, which, in turn, routes the signals to the System 14 and/or the data store 4. The MSC 8 communicates with the System 14 using a signaling interface, an IP Interface, or any other interface that facilitates communication. For example, the System 14 is integrated with the MSC 8 over a communication link, such as the SS7, TCP/IP, or other signalling protocols that are currently known or will be known in the art.

The System 14 first analyzes the signal received from the mobile device 9. Generally, the System 14 determines at least the location of the signal, the compatibility of the signal, and the availability of roaming networks 10, 11, 12. Accordingly, the System 14 determines the origin of the signal (i.e., the location of the roaming mobile device 9).

Optionally, the System 14 determines the type of the signal and to whether the signal is compatible with the home MCN. As is known in the art, the roaming MCN should be compatible with the home MCN 15 in order to carry communication signals with or without any external and/or internal communication signal conversion and/or processing. Consequently, the MCNs 10, 11, 12 and 15 are interconnected such that the mobile devices 9 can wirelessly communicate with one another on the MCNs 10, 11, 12 and 15. Accordingly, the System 14 selects the roaming MCN 10, 11, 12 using the same signal, or a compatible signal or a converted and/or processed signal, as used by the mobile device 9 and the home MCN 15.

After the System 14 analyzes the type of signal and determines the availability of roaming MCNs 10, 11, 12, the System 14 approves and selects the roaming MCNs 10, 11, 12, based on the preferred relationships with the home MCN 15. For example, the preferred relationships are based on monetary incentives (e.g., potential revenues) that can be generated by using a particular roaming MCN 10, 11, 12. In another variation, the preference is based only on contractual or preferred relationships between the home MCN 15 and the roaming MCN 10, 11. In an additional variation, the System 14 preferences the MCNs based on such factors as quality of service, revenue/cost, and negotiated priority of affiliated MCNs.

In accordance with one embodiment of the present invention, the System 14 only approves the use of a preferred MCN 10, 11 because the preferred networks have an existing relationship with the home MCN. In some instances, multiple preferred MCNs are available. In such cases, the preferred MCNs 10, 11 that are available to the home MCN 15 are hierarchically categorized and labelled with a ranking, such as Preferred Network 1, Preferred Network 2, and so forth. In one variation, the System 14 uses the rankings to prioritize preferred MCNs (interchangeably referred to herein as “most preferred”), and the System 14 selects the most preferred MCN.

In one embodiment, the System 14 has built in intelligence to allow the subscriber to log on to unaffiliated MCNs 12 if, for example, the preferred MCNs 10, 11 are not available. In a variation of this embodiment, if multiple unaffiliated MCNs 12 are available, the System 14 prioritizes the unaffiliated MCNs 12 based on predetermined factors, customizable by each home MCN 15, including such factors as cost and quality of service. The System 14 subsequently selects one unaffiliated MCN 12, when a preferred MCN 10, 11 is not available. In one aspect of the present invention, the System 14 can be configured to allow or disallow roaming subscribers from connecting to unaffiliated MCNs 12.

In one variation of the present invention, as shown in FIG. 1, either upon the request of the subscriber or automatically as programmed (i.e., automatically activated when the mobile device 9 is turned “on”), the mobile device 9 transmits a signal, which includes identification information (e.g., about the subscriber and home MCN of the subscriber), to available MCNs 10, 11, 12.

The mobile device 9 of the subscriber attempts to log on to the roaming MCNs 10, 11, 12, and each roaming MCN 10, 11, 12, in turn, communicates with the home MCN 15. In one embodiment, the roaming MCN 10, 11, 12 transmits signals to the MSC 8 of the home MCN 15. Accordingly, the roaming MCN 10, 11, 12 communicates with the home MCN 15 to obtain log on confirmation and/or approval from the home MCN 15. In one variation, the roaming MCNs 10, 11, 12 communicates with the MSC 8 of the home MCN 15 using the SS7 or TCP/IP interfaces.

In one variation, the MSC 8 of the home MCN 15 receives the signal either directly from the mobile device 9 via the home MSC 8 or indirectly from mobile device 9 via the MCNs 10, 11, 12 and home MSC 8. The MSC 8 communicates with the System 14, which contains one or more data stores 4. The System 14 analyzes the signal against information in the data store 4 related to the mobile device 9. The data store 4 may contain information on the networks present and available in a particular geographic location. The available MCNs may be mapped in order of preference, in another variation.

The System 14 of the present invention responds to the signal (i.e., a confirmation and/or approval request from the mobile device 9 or the MCNs 10, 11, 12) by providing confirmation and/or approval to one preferred MCN 10, 11, in accordance with one variation. In another variation, the System 14 provides confirmation and/or approval to unaffiliated MCNs 10 if no preferred MCN is available (e.g., availability may be based on the signal strength of the unaffiliated MCNs).

In one variation, the log on process to the unaffiliated MCN 12 requires confirmation and/or approval by the System 14. In one other variation, if the request to log on 1 is coming from an unaffiliated MCN 12, then the request 1 is rejected by the System 14. In yet another variation, if a first request fails, the mobile device attempts to log on to a second roaming MCN, wherein the second roaming MCN requests confirmation and/or approval from the System 14 of the home MCN 15. This approval process may be repeated sequentially until successful. In an alternate variation, in the event that no preferred MCNs 10, 11 are available, the System 14 allows the mobile device 9 to log on to an unaffiliated MCN 12.

As further illustrated in FIG. 1, at least one of the available MCNs 10, 11, 12 receives the signals from the mobile device 9. The available MCNs 10, 11, 12 process the signal to obtain the subscriber's identification (e.g., home MCN), in one variation. The available MCNs 10, 11, 12 transmit a second signal, generally including the subscriber's identification information, to register and authenticate (also referred to collectively herein as “log on”) the subscriber to the home MCN and to obtain confirmation and/or approval from the home MCN 15 to serve as the roaming MCN. In one variation, the “log on” process is an initial request for and provides the available MCNs 10, 11, 12 with the mobile device's 9 location information 1, 2, 3. This process of requesting and responding to the location information 1, 2, 3 is commonly referred to as the “location update.”

As a result of the log on process, the subscriber is functionally connectable to each of the available MCNs 10, 11, 12, but is not actually operable on any one roaming MCN 10, 11, 12. In one embodiment, to be fully operable, i.e., to be able to use the mobile device 9, the System 14 of the home MCN 15 selects one MCN from the list of available MCNs 10, 11, 12 requesting permission.

As noted previously, the mobile device 9 conventionally connects to the MCN with the strongest signal. In accordance with one embodiment of the present invention, the System 14 processes the list of available roaming MCNs 10, 11, 12 using a series of criteria. In one variation of the present invention, the process uses one or more of the following criteria: compatibility with the available MCNs, contractual obligations between the home MCN and the available MCNs, monetary incentives between the home MCN 15 and the available MCNs 10, 11, 12, signal strength, and quality of service associated with the available MCNs 10, 11, 12. In another variation, the selection of the available roaming MCN 10, 11, 12 depends on the contractual obligations between the home MCN 15 and the preferred MCN 10, 11. In yet another variation, among multiple preferred MCNs 10, 11, the System 14 selects the most cost-efficient preferred MCN 11. In one more variation, if no contractual obligations exist between the home MCN 15 and the available roaming MCNs 12, the System 14 defaults to the roaming MCN having the strongest signal strength.

In another variation of the present invention, a signal transmits from the mobile device 9 to the home MCN 15, wherein the System 14 determines the available MCNs 10, 11, 12 to the mobile device 9. In yet another variation, the System 14 directs the mobile device 9 to select the one or more available roaming MCNs 10, 11, 12, as detected by the System 14. The System 14 obtains and provides the location update 1, 3, 6, as necessary, in accordance with one variation.

In an additional embodiment of the present invention, the System 14 also has the intelligence to restart the registration and authentication process, if necessary. In one variation, the System 14 restarts the registration and authentication process when the mobile device 9 is activated, re-activated, or comes back into range (i.e., the geographic area in which the mobile device 9 is serviceable by a MCN). In another variation, the System 14 restarts the process if the System detects any errors and/or malfunctions. In yet another variation, the System 14 can monitor and/or log and/or generate reports to provide the home MCN 15 with a review of the activities performed by the System 14. The System 14 can also provide interactive user interfaces to access such activity logs and reports.

The process to determine the availability of roaming MCNs is another aspect of the present invention. The System 14 either identifies available MCNs sequentially or simultaneously. In one variation of the present invention, the log on process is conducted sequentially, i.e., the System 14 identifies MCNs one at a time and determines the availability and compatibility of a first MCN, before conducting the same process with a second MCN. In this variation, the System 14 identifies the available MCNs 10, 11, 12 and preferences them, as described previously. Accordingly, the System 14 first attempts to log on 5 to a primary preferred MCN 11, the priority of the MCN being determined by the System 14, as described previously. If the attempt to log on to the primary MCN 11 fails (and/or the primary preference is unavailable), the System 14 attempts to log on 7 to a secondary preferred MCN 10. This process continues through a hierarchy of preferred MCNs 10, 11 until a MCN is selected and the log on process is successful. Successful log on 5 allows the mobile device 9 to become operable using the selected MCN.

In an alternate embodiment in which the System 14 determines more than one available MCN 10, 11, 12, the System 14 functionally groups all of the primary preferred MCNs 10, 11, and then attempts to simultaneously log on to each preferred MCN 10, 11.

There are several exemplary methods used by the System 14 to select one MCN from amongst the available preferred MCNs. In a first variation, the System 14 selects the MCN that is first to allow the mobile device 9 to log on from amongst the multiple preferred MCNs 10, 11 available. In a second variation, the System 14 attempts to simultaneously log on to one or more MCN 10, 11, 12 and accepts connection from the most preferred MCN 11 (as determined by the home MCN's 15 contractual obligations and agreements, for example). In a third variation, the System 14 provides a predetermined period of time for preferred MCNs 10, 11 to respond to the mobile device's 9 log on request, thereby providing each available MCNs 10, 11, 12 a chance to respond prior to selecting the roaming MCN. At the end of the period of time, the System 14 selects the more preferred MCN 11 of the MCNs providing a response. It is understood to one skilled in the art that these variations are exemplary and that additional selection methods are also conceived by the present invention.

The System 14 of the present invention ensures that subscribers primarily log on to the home MCN 15 (if within range and available) or the preferred MCN 10, 11. Accordingly, in the present invention, the System 14 ensures increased revenues to the home MCN 15 and the probability of better service to the subscriber.

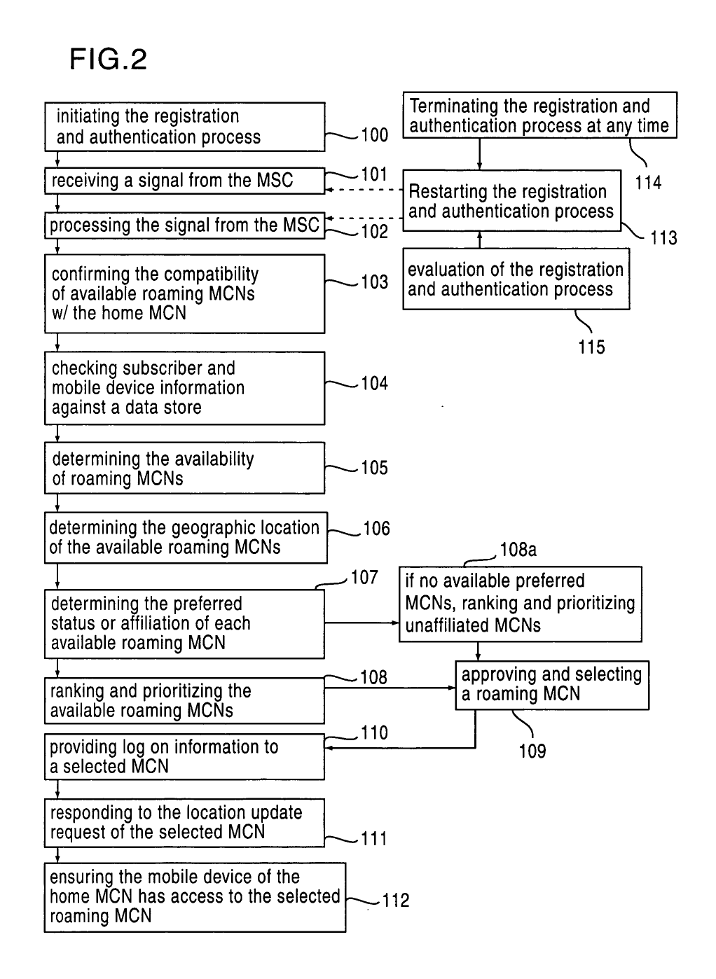

As generally discussed above, the present invention controls the routing of roaming signals. FIG. 2 provides an exemplary flow diagram of the operation of the system of the present invention. The system initiates the registration and authentication process at step 100 to allow signals to be received at step 101. In one variation, the system initiates the process by powering on. In another variation, the system maintains a state of readiness to receive a signal. Once the signal is received from the MSC at step 101, the signal is processed by the system at step 102. The system confirms the compatibility of the roaming MCNs sending the signals to the home MCN at step 103. The system then checks subscriber and mobile device information against at least one data store at step 104. The system subsequently determines the availability of the roaming MCNs at step 105, and the geographic location of each available roaming MCN at step 106.

After the system collects the necessary data regarding the roaming MCNs, the system assesses whether the available MCNs have preexisting relationships with the home MCN. In particular, this step involves determining the preferred status or affiliation of each available roaming MCN at step 107. If more than one preferred available roaming MCN is located, the system ranks the preferred roaming MCNs at step 108. Alternatively, if no available preferred roaming MCN is found, the system ranks the unaffiliated roaming MCNs at step 108a, in the event that multiple unaffiliated roaming MCNs are available. It is understood in the art that the criteria for ranking MCNs are based on the business practices of home MCN.

One of the ranked MCNs is approved and selected by the system at step 109. In one variation, the most preferred MCN is selected from among the ranked preferred MCNs. The system then provides log on information to the selected MCN at step 110. The system also responds to requests (e.g., location update requests) sent by the selected MCN to the home MCN at step 111. Accordingly, the system ensures that the mobile device subscribed to the home MCN has access to the selected roaming MCN at step 112.

The system has built in intelligence to constantly evaluate whether the registration and authentication process described herein is operating successfully and/or without errors at step 115. Accordingly, the system has the ability to terminate, at step 114, and/or restart, at step 113, the process at any time, as necessary.

Among other advantages, the present invention enables MCN providers to have control over the subscribers and MCNs to be used outside of the range of the home MCN. For example, the present invention allows the home MCN to basically dictate the MCN used by roaming subscribers. More specifically, the System provides control to the home MCN provider to ensure that the roaming subscribers use preferred MCNs exclusively. Additionally, the System provides coverage flexibility, ensuring that the mobile device is operable on at least one network. For example, if the preferred MCN selected by the System is unavailable due to whatever reason, the System allows the roaming subscriber to log onto another preferred MCN, or at least an unaffiliated MCN.

The present invention includes numerous other advantages. For instance, if the subscriber manually tries to log onto an unaffiliated MCN, the System can reject the attempt. In one variation, the System can redirect the subscriber to a preferred MCN. In another variation, the System can connect the subscriber to an unaffiliated MCN in certain instances or if certain thresholds known in the art or selected by the home MCN are met. For example, in one additional variation of the present invention, if the roaming subscriber repeatedly tries (e.g., several attempts) to log onto an unaffiliated MCN, which may indicate an emergency, the System can allow the connection to an unaffiliated MCN. In one variation, the number of such attempts after which the subscriber is allowed to log onto an unaffiliated MCN can be configured by the System. In another variation, the option to allow a Subscriber to log on to an unaffiliated Network after repeated attempts can be enabled or disabled by the home Network.

The present invention is incorporated into the home MCN using an operating system, which also ensures that the signaling and billing elements are seamlessly integrated in real-time. The operating system includes several functional layers, including a network broker layer (NBL), business logic layer, and an application interface layer, which communicate with each other using industry standard protocols. Descriptions of the network broker layer and application interface layer are provided in applicants' copending U.S. patent application filed on May 21, 2004 having Ser. No. 10/850,561 titled “System for A Wireless Intelligent Services Engine.” The business logic layer includes configurations for the network, the data store, and the processing system, as well as logic to determine preferred status based on business practices.

The operating system controls and configures access of the system of the present invention to the data store and wireless network. An initializer executes a file having configuration information by initiating one or more standard communication protocols. A converter receiving the communications on the standard communication protocol converts the communication to an application programming interface format. Using a broker and parser, the operating system communicates with the data store, for example. The communications are recorded as thread pools and connection pools.

The operating system optionally includes a system manager, which monitors the activities of the operating system and reports, for example, by signaling an alarm, upon failure in operation of the broker, the converter, the plurality of protocol selections, the initializer, the data store and/or the file having configuration information.

With the present invention, MCN providers have the ability to control and monitor roaming usage using a networked-based solution. MCN providers have the potential to increase their revenue generation, even during roaming, via preferred roaming ties with preferred MCNs.

Example Processing System Components and Functionality

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 2.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While there has been described what are at present considered to be preferred embodiments of the present invention, it will be understood that various modifications may be made thereto, and it is intended that the appended claims cover all such modifications as fall within the true spirit and scope of the invention. Other modifications will be apparent to those skilled in the art.

1. A system for accessing wireless networks, comprising:
a processing system communicable with a home mobile communications network, wherein the processing system receives and analyzes signals from one or more roaming mobile communications networks, and wherein the home mobile communication network selects a roaming mobile communication network from one or more available roaming mobile communications networks.

2. The system according to claim 1, wherein the processing system further comprises a data store and a mobile switching center.

3. The system according to claim 2, wherein the processing system interfaces with the data store and mobile switching center connected to the home mobile communications network.

4. The system according to claim 3, wherein the data store comprises information selected from the group consisting of subscribers, signaling, and available roaming mobile communications networks.

5. The system according to claim 3, wherein the processing system interfaces with the data store to confirm subscriber status.

6. The system according to claim 1, wherein the processing system is integrated with the home mobile communications network.

7. The system according to claim 1, wherein the signal receivable by the processing system includes a request for a location update.

8. The system according to claim 7, wherein the home mobile communications network provides a location update to at least one roaming mobile communications network.

9. The system according to claim 1, wherein the processing system sequentially analyzes the signal from each roaming mobile communications network.

10. The system according to claim 1, wherein the home mobile communication network selects a preferred roaming mobile communication network.

11. The system according to claim 10, wherein a preferred status is based on at least one selected from the group consisting of contractual obligation, monetary incentives, network capacity, quality of service, signal strength, and business practices.

12. The system according to claim 1, wherein the system is network-based.

13. The system according to claim 1, wherein the system is fully scaleable.

14. The system according to claim 1, wherein the system is fully customizable.

15. The system according to claim 1, wherein the system is compatible with industry standard applications.

16. The system according to claim 15, wherein the available roaming mobile communications networks use a signaling system that is compatible with the signaling system of the home mobile communication network.

17. The system according to claim 15, wherein industry standard applications include at least one selected from a group consisting of common channel signaling system number 7, common channel signaling system number 8, and transmission control protocol/internet protocol.

18. A method of selecting a roaming mobile communications network by a home mobile communications network, comprising:
receiving a signal from at least one roaming mobile communications network which received a signal from a mobile device subscribed to a home mobile communications network;
analyzing the at least one available roaming mobile communications networks for preferred status; and
selecting a preferred roaming mobile communications network to carry communication signals of the mobile device.

19. The method of claim 18, further comprising:
locating the geographic position of the mobile device.

20. The method of claim 18, further comprising:
ranking the at least one available preferred roaming mobile communications networks, and selecting the most preferred.

21. The method of claim 18, further comprising:
analyzing the signal from the at least one roaming mobile communications network against a data store.

22. The method of claim 18, further comprising:
determining registration and identification of a subscriber of the mobile device.

23. The method of claim 18, further comprising:
allowing the mobile device to log on to one preferred roaming mobile communications network.

24. An article of manufacture, comprising:
a computer readable medium; and
a data structure stored on the medium for routing wireless signals, wherein the data structure comprises a computer readable system for routing wireless signals comprising:
initiating a process for routing the wireless roaming signals receiving a wireless roaming signal;
processing said received roaming signal;
confirming the compatibility of the roaming signal with the home MCN;
checking subscriber and mobile device information against a data store;
determining the availability of roaming MCNs;
determining the geographic location of the available roaming MCNs;
determining the preferred status of each available roaming MCN;
ranking the available roaming MCNs approving and selecting one available MCN;
communicating with the a selected MCN;
ensuring a mobile device has access to the selected MCN; and
terminating said process.

25. A system for routing wireless roaming signals, the system comprising:
initiating means for initiating a process for routing the wireless roaming signals receiving means for receiving a wireless roaming signal;
processing means for processing said received roaming signal;
confirming means for confirming the compatibility of the roaming signal with the home MCN;
checking means for checking subscriber and mobile device information against a data store;
determining means for determining the availability of roaming MCNs;
determining means for determining the geographic location of the available roaming MCNs;
determining means for determining the preferred status of each available roaming MCN;
ranking means for ranking the available roaming MCNs approving and selecting means for approving and selecting one available MCN;
communicating means for communicating with the a selected MCN;
ensuring means for ensuring a mobile device has access to the selected MCN; and
terminating means for terminating said process.

26. The system of claim 25, wherein the approved and selected MCN is a preferred MCN.

27. The system of claim 25, wherein the ranking means ranks available preferred MCNs.

28. The system of claim 25, wherein the communication includes log on information.

29. The system of claim 25, wherein the communication includes a response to a location request from the selected MCN.

30. The system of claim 25, wherein no preferred MCN is available, further comprising:
ranking means for ranking unaffiliated MCNs; and
approving and selecting means for approving and selecting the unaffiliated MCN.

31. The system of claim 25, further comprising:
monitoring means for monitoring system activities;
maintaining means maintaining a log of system activities; and
optionally a generating means for generating reports regarding system activities.

32. The system of claim 4, wherein the processing system further comprises:
an operating system that interfaces with the processing system.

33. The system of claim 32, wherein the operating system further compromises:
a broker layer;
a business logic layer; and
an application interface layer.

34. The system of claim 33, wherein the operating system includes signaling and billing elements that are seamlessly integrated in real-time.

35. The system of claim 33, wherein the network broker layer, the business logic layer and the application interface layer communicate via industry standard protocols.

36. The system according to claim 33, wherein the business logic layer further comprises:
Configuration features for the network, the data store, and the processing system; and
logic features to determine preferred status based on business practices.

37. The system of claim 33, wherein the operating system further comprises:
a file having configuration information;
an initializer that executes the file having configuration information;
a plurality of protocol selections initiated by the initializer to communicate with the network;
a converter that receives messages from the plurality of protocol selections and converting the messages to an application programming interface format;
a broker providing an interface to access the network;
a parser that converts between extensible markup language and the application programming interface format;
at least one thread pool, each thread pool managing request and response sequences communicated with the data store;
a connection pool providing connectivities to the data store; and
a system manager that monitors the functions of the initializer, the file having configuration information, the plurality of protocol selections, the converter, the parser, and the broker.

38. The system of claim 37, wherein the operating system further comprises:
an alarm signaled upon failure in operation of one selected from a group consisting of the broker, the converter, the plurality of protocol selections, the initializer, the data store, and the file having configuration information.
